(19) United States
(12) Patent Application Publication
(10) Pub. No.: US 2005/0119476 A1
(43) Pub. Date: Jun. 2, 2005

(54) Method for improving the colour index of cellulose esters

(75) Inventor: Hans Steinmeier, Teningen (DE)

Correspondence Address: DARBY & DARBY P.C., P. O. BOX 5257, NEW YORK, NY, 10150-5257, US

(73) Assignee: Rhodia Acetow GmbH, Freiburg (DE)

(21) Appl. No.: 10/499,881

(22) PCT Filed: Dec. 12, 2002
(86) PCT No.: PCT/EP02/14164

(30) Foreign Application Priority Data
Dec. 21, 2001 (DE) 101 63 303.3

(51) Int. Cl. C08B 1/02

(52) U.S. Cl. 536/70

(57) ABSTRACT

The invention relates to a method for improving the colour index of cellulose esters especially consisting of cellulose acetate. According to the inventive method, a delignified eucalyptus pulp is subjected to a preliminary treatment in order to remove pigments or chromophoric substances, and the process-modified eucalyptus pulp obtained is converted into cellulose esters in a conventional manner. The inventive method is characterized in that a delignified eucalyptus pulp having a cellulose content of more than approximately 80 wt. % and a pentosan content of more than approximately 1 wt. % is extracted by means of a solvent which dissolves oligomer pentosans but not the pulp of the delignified eucalyptus pulp, especially at a temperature of up to approximately 200 ° C. and a pressure of up to approximately 30 bar. The inventive method leads to an improvement in the colour index of cellulose esters or the fibres and filaments produced therefrom, in an economical and technically simple manner.

The invention relates to a method for improving the color index of cellulose esters, especially consisting of cellulose acetate, wherein a delignified eucalyptus pulp is subjected to a preliminary treatment in order to remove pigments and/or chromophoric substances, and the process-modified eucalyptus pulp that is obtained is converted into cellulose esters in a conventional manner.

The invention is based upon the problem that in the further processing of sheets of delignified eucalyptus pulp to cellulose esters, especially to cellulose acetate, color problems can arise. Such problems emerge especially when the cellulose esters are processed to form fibers or filaments to be used in filter materials for cigarettes. The process of using acetic acid to activate pulp in order to support a subsequent acetylation is already known. However the pigments or chromophoric substances are not removed in this process. They remain in the system and lead later to an undesirably high color index, for example in the cellulose ester fibers. EP 0 503 304 A1 describes a method for treating raw materials containing cellulose with a pulping liquor comprised of concentrated aqueous acetic acid at an increased temperature and increased pressure. This is intended first to delignify the raw material containing the cellulose. This process is subject to relatively severe limitations. For instance, the aqueous acetic acid that is used must have a water content of between 5 and 50 wt. %, the temperature must lie between 140 and 230° C., and the pressure must lie between 3 and 30 bar. A bleaching with ozone is imperative. With this, pigments and chromophoric components are also bleached. They further lead in the esterification and the processing into fibers or filaments to the above-mentioned color problems. A correlation exists between the color index of a given cellulose ester and the material that is spun into fibers or filaments.

The degree of purity of the cellulose ester that is obtained, especially of the cellulose acetate, plays a major role in special areas of application for cellulose derivatives, e.g. filter tow, textiles or plastic compounds. In this, the above-mentioned color index is an indicator of the degree of purity. The prerequisite for fulfilling the requirement of a low color index in cellulose acetate is high brightness levels in the pulp that is used. Depending upon the process and the raw material, especially when eucalyptus wood is used to produce the pulp, this requirement is not always fulfilled. The chromophoric components such as pentosans, resins, waxes, and other resonant organic substances that are very difficult to identify remain in the pulp and under acetylation conditions can lead to a definite yellowing of the cellulose acetate. In the cellulose acetate process, the bleaching of chromophoric components of this type is dependent upon potassium permanganate or hydrogen peroxide, for example. The use of eucalyptus pulps can thus lead to increased yellowing in the final product or to a poor color index. The color index is determined via an extinction of a 2 wt. % cellulose ester solution, especially a cellulose acetate solution, in formic acid, measured in a cuvette having a path length of 10 mm by 420 nm, and multiplied by the number 1000 (color index=extinction (420 nm)×1000). Especially in the case of cellulose acetate, the color index is a very good indicator of the brightness of the corresponding end product, e.g. a filter tow.

The object of the invention was to improve upon the method described at the beginning such that both the cellulose ester that is obtained and the fibers or filaments produced therefrom exhibit a desirable improvement in the color index.

This object is attained in accordance with the invention in that in the method described at the beginning a delignified eucalyptus pulp having a cellulose content of more than approximately 80 wt. % and a pentosan content of more than approximately 1 wt. % is extracted by means of a solvent which dissolves oligomer pentosans but not the pulp of the delignified eucalyptus pulp, especially at a temperature of up to approximately 200° C. and a pressure of up to approximately 30 bar.

The parent material for the method specified in the invention is a delignified eucalyptus pulp. The delignification of woods is the current state of the art. The process described above in connection with EP 0 503 304 A1, for example, may be used for this. For the purposes of the invention, the pulp from eucalyptus wood raw material, which is renewed very quickly, can be used, and this pulp has an advantage over other pulps, such as coniferous and deciduous wood pulps. It must be adequately delignified.

The delignified pulp, supplied in the form of a pressed material is first expediently processed into fibers using customary apparatus, if necessary with the addition of small quantities of customary additives, such as sulphuric acid, and preferably is held for a certain amount of time at room temperature, up to an increased temperature (up to 140° C.). The desired result is obtained especially when a delignified eucalyptus pulp having a cellulose content of more than 80 wt. %, especially more than approximately 88 wt. %, is used. The pentosan content may also lie above approximately 1 wt. %, especially between approximately 1.5 and 3 wt. %. If the pentosan content is under 1 wt. %, then there is generally already per se a satisfactory color index in the cellulose esters or fibers and filaments produced therefrom. The preferred pentosan content ranges from approximately 1.5 to 3 wt. %. If the level of 3 wt. % is exceeded, then in addition to a significant coloration, other disruptive effects can emerge in the processing to cellulose esters, such as low filtration values or increased opacities in the reaction solutions.

If the delignified eucalyptus pulp has a very high and disadvantageous moisture content, for example on a magnitude of approximately 7 to approximately 12 wt. %, it is generally advantageous for this parent material to be subjected to preliminary drying. In some cases it can also be beneficial to perform a degasification prior to the extraction. This can be accomplished, for example, via a customary acetic acid vacuum evaporation.

In selecting the extraction material, it is necessary for the specialist in the field to consider only that the solvent that is used must dissolve the oligomeric pentosans, especially xylan, but must not or must only insignificantly dissolve the delignified eucalyptus pulp. It is easy for a specialist in the field to find suitable solvents that will fulfill these framework conditions. These may include, for example, acetone, and especially carboxylic acids, preferably C₁-C₄ aliphatic monocarboxylic acids or mixtures of these. Of particular advantage is the use of highly concentrated aqueous acetic acid, especially having a content of approximately 80 to 99 wt. % acetic acid.

If the above-described solvents are used, not only are the oligomeric pentosans extracted, which is a primary goal of the invention, but all other disruptive or chromophoric substances, including hemicelluloses, waxes, and resins, are also extracted.

The further process conditions, such as temperature, pressure and process duration, are not critical. It is preferred that the temperature during extraction under standard pressure be between approximately 15 and 30° C., and the duration of the extraction be between approximately 5 minutes and 2 hours, especially between approximately 10 and 60 minutes.

The nature of the extraction also is not critical for the invention. Thus the delignified eucalyptus pulp is extracted in a conventional extractor, wherein it is beneficial for the extraction to be carried out in a continuous countercurrent. In detail, the process may be as follows: The pulp is formed into fibers, e.g. in a liquor ratio of approximately 1:20 with acetic acid in a mixing vat, after which it is pressed off via a press to a residual content of approximately 50 wt. % acetic acid, and is placed on a conveyor belt that is permeable to acetic acid. Based upon the length of the conveyor belt, a desirable number of extraction steps in the countercurrent principle can be realized. In any extraction step an inorganic acid, e.g. sulphuric acid, may be added. However, the extraction steps may also be realized continuously, discontinuously, or quasi-continuously using screw presses. The extraction is expediently conducted until the pentosans or the disruptive chromophoric substances, and especially resinous compounds, are removed to such an extent that the cellulose esters that ultimately are obtained by means of acetylation will possess a maximum color index of approximately 18, especially a maximum of approximately 15.

The central focus of the method specified is to remove the pentosans and chromophoric compounds. In this, a specialist in the field will preferably control the extraction in such a way that in addition to the pentosans especially resinous companion substances are also largely extracted. To support this process it is expediently provided that a strong inorganic acid, especially sulphuric acid, is added to the extraction medium at the end of the extraction process. This is preferably followed by a further extraction process lasting approximately 5 to 15 minutes. The quantity of sulphuric acid relative to delignified eucalyptus pulp (dry mass) amounts to approximately 1 part by weight sulphuric acid or strong inorganic acid to approximately 10 to 200 parts by weight delignified eucalyptus pulp (dry substance).

For the further reaction to esters, it has proven advantageous for the process-modified eucalyptus pulp to be treated in a tempering device for approximately 5 to 45 minutes, especially approximately 10 to 30 minutes, at a temperature of approximately 25 to 50° C., especially approximately 30 to 35° C. The tempering device may have the following construction: A mixing vat, which is provided with a double mantel, for example, allowing it to heat the contents of the vat to the desired temperature by means of a heat exchanger liquid. Alternatively, however, an insulated mixing vat may be used, if the extracting agent is heated to the desired temperature prior to filling, for example via a heat exchanger.

The principal goal of the process is for the process-modified eucalyptus pulp to be converted to a cellulose ester, especially cellulose acetate. In the latter case it is of particular advantage for the acetylation to be accomplished using acetic anhydride. This is a customary process, in which preferably the pretreated, acetic acid-moist pulp, to the extent that it is not already present in the extracting agent, is converted first to cellulose triacetate using a catalyst, e.g. sulphuric acid, and then using acetic anhydride. This is followed by the establishment of a process-dependent water content level, and then controlled hydrolysis to cellulose acetate. The acetyl value can be adjusted via the conditions of hydrolysis.

The product of the process in the form of a cellulose ester, especially in the form of cellulose acetate, can be further processed via conventional means to formed pieces, especially to fibers and filaments that are used in filter tow for filter cigarettes. This is accomplished, for example, by dissolving the cellulose acetate, depending upon the process, in a certain quantity of acetone, and following a subsequent filtration, spinning it in a dry spinning process.

Upon completion of the extraction, excess extracting agent is removed, e.g. via pressing, and/or is exchanged in the countercurrent with pure extracting agent. A balanced surplus of the extracting agent that is charged with the eluted components is treated in a separate process. Known processes, such as total hydrolysis, ultrafiltration, distillation, chromatography, or a combination of these for example, may be used for this. The purified extracting agents are preferably recycled and reused for the process.

The advantages that are associated with the present invention may be represented as follows: The inventive method is first economical and produces no harmful effects on the environment. With a simple extraction of delignified eucalyptus pulps using, for example, acetic acid, the content of chromophoric components is significantly reduced. In this, water content levels in the acetic acid of up to 20% are non-problematic, and even lead to further benefits. Thus the yellowing of cellulose acetate can be significantly reduced if the process-modified delignified eucalyptus pulp is subjected to the extraction specified in the invention, especially acetic acid extraction, prior to acetylation, after which the acylated or acetylated pulp is reduced using customary techniques (pressing) to solids contents of approximately 50%. The solvents used in the extraction, especially acetic acid, and the solvents that are pressed off, especially carboxylic acid, can be reused in the extraction process following a purification stage (for example distillation). In the acetylation, the extracting agent acetic acid may remain in the pulp, because in an acetylation process it is a component of the customary reaction medium. Here, the disadvantage of other extracting agents relative to acetic acid is that prior to acetylation they must be largely removed, which requires some expenditure. Particularly surprising is the following circumstance: When fibers or filaments are produced from cellulose acetate from an acetone solution using a dry spinning process, disadvantageous, chromophoric substances, including pentosans, can continue to appear in the end product. If, however, the extraction specified in the invention is performed beforehand, for example with acetic acid as the extracting agent, then surprisingly this no longer occurs. Instead, the product that is obtained fulfills the requirements with respect to a low color index. Further, it has been determined that with only a simple extraction of delignified eucalyptus pulp using acetic acid, the chromophoric components can be reduced. In this, a water content in the acetic acid of up to 20% causes no disruption. Depending upon the degree of purity of the delignified eucalyptus pulp that is used, up to 1 wt. % of deep dark brown substances, and in some cases even more, is removed.

The invention will be described in greater detail below, with reference to examples:

### EXAMPLE

In each of four examples, 10 g of air-dried, delignified eucalyptus pulp were used. The test samples A, B, C, and D described below were processed, evaluated and/or compared.

A: Processed manually into fibers acetylated without further treatment,

B: Extracted as specified in the invention in 500 ml acetic acid at room temperature for 120 minutes, then filtered off,

C: Extracted as specified in the invention in 500 ml acetic acid at 50° C. for 120 minutes, then filtered off,

D: Extracted as specified in the invention in 500 ml acetic acid at 100° C. for 120 minutes, then filtered off.

The obtained process-modified eucalyptus pulp was subjected to an activation as follows:

The extracted eucalyptus pulp was weighed into a 250 ml threaded flask. This was filled to volume with 100 ml glacial acetic acid. The flask was sealed and clamped inside an overhead mixer. The flask was allowed to rotate from overhead for 3 days at approximately 20 rpm. On the fourth day, 50 ml of glacial acetic acid and 0.3 ml concentrated sulphuric acid were added. It was allowed to rotate from overhead for another 2 hours for activation. The activation was followed by an acetylation. In this the process-modified eucalyptus pulp was transferred to a tempering vessel that had been heated to 35° C. Tempering took place for 15 minutes. Then, with the addition of 50 ml acetic anhydride, the acetylation and at the same time the stirrer were started. During the acetylation, the viscosity of the reaction mixture was controlled. The reaction mixture was drawn using a Peleus ball and a glass tube (inner diameter 5 mm) up to a marker (20 cm from the end of the tube). The Peleus ball was then removed and the reaction mixture was allowed to flow out of the glass tube, which was held in a vertical position. In this process the time required by the reaction mixture to flow out completely from the mark was noted. When only 30 seconds of this time were left, the acetylation was interrupted by adding 15 ml 60-% acetic acid, which at the same time initiated the hydrolysis. The solution was stirred for another 4-5 hours at 70° C. and, once the acetyl value of approximately 55.0 had been reached, the cellulose acetate was precipitated in water and dried. It can be processed using customary methods into fibers or filaments, and these can be used in the filter tow for cigarette filters.

The determination of color index was accomplished as follows:

2 g dry cellulose acetate were dissolved in 100 ml formic acid. The solution was then centrifuged for 10 minutes at 3000 rpm, and decanted. The extinction of the solution was measured in a photometer at 420 nm. The color index is the extinction multiplied by the number 1000.

Results:

| Sample: | Color Index |
|---|---|
| A | 32 |
| B | 18 |
| C | 15 |
| D | 18 |

The comparison shows that the processed, delignified eucalyptus pulps produce a markedly improved color index, i.e. the color index of the untreated product is 32, while the products treated as specified in the invention lead to color indexes of 18, 15, and 18. A color index of 18 or less easily fulfills the requirements of the subsequent processor, especially in the case of further processing to filter tow.

1. Method for improving the color index of cellulose esters, especially comprised of cellulose acetate, wherein a delignified eucalyptus pulp is subjected to a preliminary treatment in order to remove pigments and/or chromophoric substances, and the process-modified eucalyptus pulp obtained is converted into cellulose esters in a conventional manner, characterized in that a delignified eucalyptus pulp having a cellulose content of more than approximately 80 wt. % and a pentosan content of more than approximately 1 wt. % is extracted by means of a solvent that dissolves oligomeric pentosans but not the pulp of the delignified eucalyptus pulp, especially at a temperature of up to approximately 200° C. and a pressure of up to approximately 30 bar.

2. Method in accordance with claim 1, characterized in that a delignified eucalyptus pulp having a pentosan content of approximately 1.5 to 3 wt. % and/or a cellulose content of more than approximately 88 wt. % is extracted.

3. Method in accordance with claim 1 or 2, characterized in that the extraction is carried out using a carboxylic acid, especially a C₁-C₄ aliphatic monocarboxylic acid or a mixture of these.

4. Method in accordance with claim 3, characterized in that the extraction is carried out using highly concentrated aqueous acetic acid, especially having a content of approximately 80 to 99 wt. % acetic acid.

5. Method in accordance with at least one of the preceding claims, characterized in that the extraction is carried out at a temperature of approximately 15 to 30° C.

6. Method in accordance with one of the preceding claims, characterized in that the extraction is carried out at a pressure of approximately 1 bar.

7. Method in accordance with at least one of the preceding claims, characterized in that the extraction is carried out over a period of approximately 5 minutes to 2 hours, especially approximately 10 to 15 minutes.

8. Method in accordance with at least one of the preceding claims, characterized in that the extraction is conducted in a continuous countercurrent.

9. Method in accordance with at least one of the preceding claims, characterized in that the delignified eucalyptus pulp is subjected to a preliminary drying.

10. Method in accordance with at least one of the preceding claims, characterized in that prior to extraction the delignified eucalyptus pulp is subjected to the degasification of an acetic acid evaporation.

11. Method in accordance with at least one of the preceding claims, characterized in that a strong inorganic acid, especially sulphuric acid, is added to the extraction medium at the end of the extraction, after which extraction is continued another 5 to 15 minutes.

12. Method in accordance with at least one of the preceding claims, characterized in that the process-modified eucalyptus pulp is treated in a tempering vessel over a period of approximately 5 to 45 minutes, at a temperature of approximately 25 to 50° C.

13. Method in accordance with at least one of the preceding claims, characterized in that the extraction is controlled such that in addition to the pentosan, especially resinous companion products are largely removed.

14. Method in accordance with at least one of the preceding claims, characterized in that the process-modified eucalyptus pulp is converted to cellulose acetate, wherein the acetylation is accomplished using acetic anhydride.

15. Method in accordance with at least one of the preceding claims, characterized in that the extraction is carried out until the cellulose ester that is obtained has a maximum color index of approximately 18, especially a maximum index of approximately 15.

16. Method in accordance with at least one of the preceding claims, characterized in that the obtained cellulose ester, especially cellulose acetate, is further processed using customary methods to form fibers or filaments.
